(19) United States
(12) Patent Application Publication
(10) Pub. No.: US 2005/0201730 A1
(43) Pub. Date: Sep. 15, 2005

(54) Digital versatile disc playback device

(75) Inventors: Yu-Chi Chen, Hsin Chu City (TW); Wen-Kuan Chen, Chu Tung Town (TW); Ying-Chih Yang, Hsin Chu City (TW)

Correspondence Address: BIRCH STEWART KOLASCH & BIRCH, PO BOX 747, FALLS CHURCH, VA, 22040-0747, US

(73) Assignee: Sunplus Technology Co., Ltd.

(21) Appl. No.: 11/062,605

(22) Filed: Feb. 22, 2005

(30) Foreign Application Priority Data
Mar. 10, 2004 (TW) 093106280

(51) Int. Cl. H04N 5/781

(52) U.S. Cl. 386/95; 386/125

(57) ABSTRACT

A digital versatile disc (DVD) playback device capable of recognizing characters comprises a character recognition unit to converse subtitle pictures recorded in a DVD into character codes. Therefore, the DVD playback device may provide useful information by analyzing the conversed character codes by means of a post process unit thereof for a use in other applications.

This application claims the benefit of the filing date of Taiwan Application Ser. No. 093106280, filed on Mar. 10, 2004, the content of which is incorporated herein by reference.

### BACKGROUND OF THE INVENTION

1. Field of Invention

The present invention relates to a digital versatile disc (DVD) playback device, and particularly to a DVD playback device capable of recognizing characters in sub-pictures by converting sub-pictures into character codes.

2. Related Art

In general, digital versatile data stored on a DVD includes versatile data, such as video, audio and subtitle, and information for playing control. When a DVD playback device playbacks a DVD, it uses a video decoder, an audio decoder and a sub-picture decoder to decode the video data, audio data and subtitle, respectively. FIG. 1 illustrates a schematic architecture of a general DVD playback device. As shown in FIG. 1, the DVD playback device 10 comprises a navigator 11, a demultiplexer 12, a decoder 13, an audio post processing unit 14, an audio output unit 15, a video post processing unit 16, a video output unit 17, a user interface 18 and a control module 19. The control module 19 outputs playing control signals to the navigator 11 in response to an input command, which is input by a user. In response to the playing control signals, the navigator 11 retrieves digital versatile data from a DVD 111 and transmits the digital versatile data into the demultiplexer 12. The demultiplexer 12 sends the audio data, video data and sub-picture units to the decoder 13. The decoder 13 includes an audio decoder 131, a video decoder 132 and a sub-picture decoder 133 for receiving and decoding the audio data, video data and sub-picture units, respectively.

Generally, the subtitle picture is recorded in the DVD in a bitmap format. FIG. 2 depicts a data structure of a sub-picture unit (SPU) used in a DVD. The SPU contains a SPH (Sub-Picture Header) 21, a PXD (Pixel Data) 22, and a Sub-Picture display control sequence table (SP_DCSQT) 23. The SPH 21 contains information associated with the dimension of a sub-picture and the displaying position of the control sequence table. The PXD 22 contains a top field data portion and a bottom field data portion and is composed of foreground color, background color, solid color 1 and solid color 2. The PXD 22 are encoded by a run-length coding scheme. The SP_DCSQT 23 contains one to several control sequences, each of which is used to control a start, an end and an attribute of a subtitle. The sub-picture decoder 133 may decode the above information and generates subtitle pictures and displaying information associated therewith, such as time, position, color contrast and the like. The subtitle picture is displayed according to the displaying time. On the other hand, the audio decoder 131, the video decoder 132 and the sub-picture decoder 133 have their outputting time sequence according to system timing.

However, there is a disadvantage existed in the current DVD playback device. The playback device only displays the subtitle pictures corresponding to the sub-picture units but not provide further information associated with characters in the subtitle pictures.

### SUMMARY OF THE INVENTION

In view of the above, it is an object of the present invention to provide a DVD playback device capable of recognizing characters in the sub-picture units.

To achieve the above object, the DVD playback device capable of recognizing characters in the sub-picture units according to the present invention comprises a control module for generating playing control signals and a character recognition control signal in response to an operation command, a navigator for retrieving versatile data, generating an output signal in response to the play control signals and generating a setting signal in response to navigation data in the sub-picture unit set as desired to be read, a demultiplexer for outputting audio data, video data and sub-picture units in response to the output signal from the navigator, an audio decoder for receiving the audio data and generating a decoded audio signal, a video decoder for receiving the video data and generating a decoded video signal, a sub-picture decoder for receiving and analyzing the sub-picture units and generating subtitle pictures and an enable signal, and a character recognition unit for recognizing characters in the subtitle pictures in response to the setting signal, character recognition control signal and the subtitle pictures.

As thus constructed, the DVD playback device capable of recognizing characters according to the present invention may output character codes of characters in the subtitle pictures and may further provide an interactive operation accordingly.

### BRIEF DESCRIPTION OF THE DRAWINGS

The invention will become more fully understood from the detailed description given hereinbelow illustration only, and thus are not limitative of the present invention, and wherein:

FIG. 1 depicts a schematic architecture of a prior DVD playback device.

FIG. 2 is a schematic structure of a sub-picture unit used in a DVD.

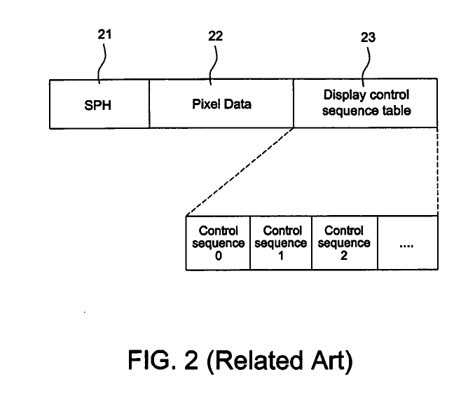

FIG. 3 is a flowchart of a method for character recognition.

FIG. 4 illustrates a block diagram of a first embodiment of a DVD playback device capable of recognizing characters according to the present invention.

FIG. 5 illustrates a block diagram of another embodiment of a DVD playback device capable of recognizing characters according to the present invention.

### DETAILED DESCRIPTION OF THE INVENTION

The DVD playback device capable of recognizing characters according to the present invention will be described in more detail with reference to the drawings.

For a general DVD playback device, a user selects some desired functions and set some parameters to playback the DVD only according to his needs or control information provided by the playing digital versatile data in the DVD. However, the present invention provides an additional function of character recognition in a DVD playback device so that the DVD playback device may provide further information in the subtitle pictures by analyzing the subtitle pictures using the character recognition function.

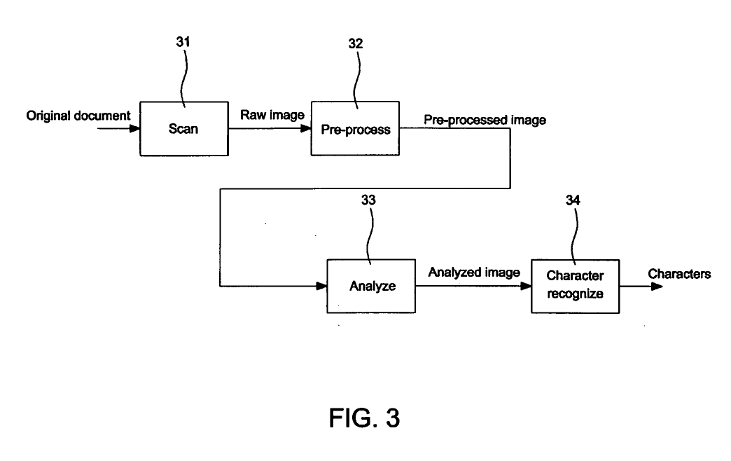

FIG. 3 shows an operation flow of a general optical character recognition. As shown in FIG. 3, a recognition system first scans an original document and then generates a raw image (Step 31). Then the recognition system pre-processes the raw image, such as inclination correctness, spot elimination and color processing, to generate a pre-processed image which is easy to be recognized (Step 32). Therefore, a succeeding character recognition operation may be smoothly performed without significant interferences according to the pre-processed image. Next, the recognition system analyzes the pre-processed image to extract character, table, picture sections and the like therein respectively and to generate an analyzed image (Step 33). Finally, the recognition system recognizes the characters in the analyzed image by use of a character library and outputting the recognized characters (Step 34), wherein a word library and a comparison of associated words are used to promote correctness of the character recognition. The character library can be selected according to different languages, fonts and forms of the characters. The word library and the associated words may also vary as the language corresponding to the recognized characters.

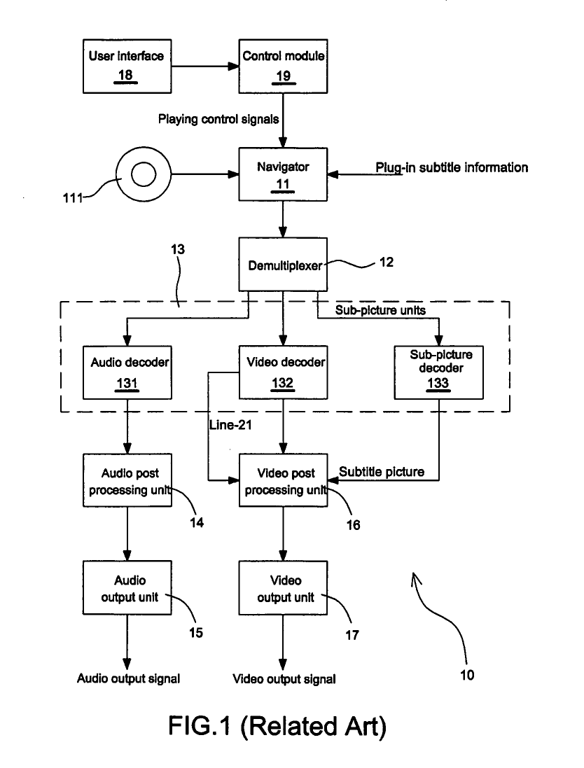

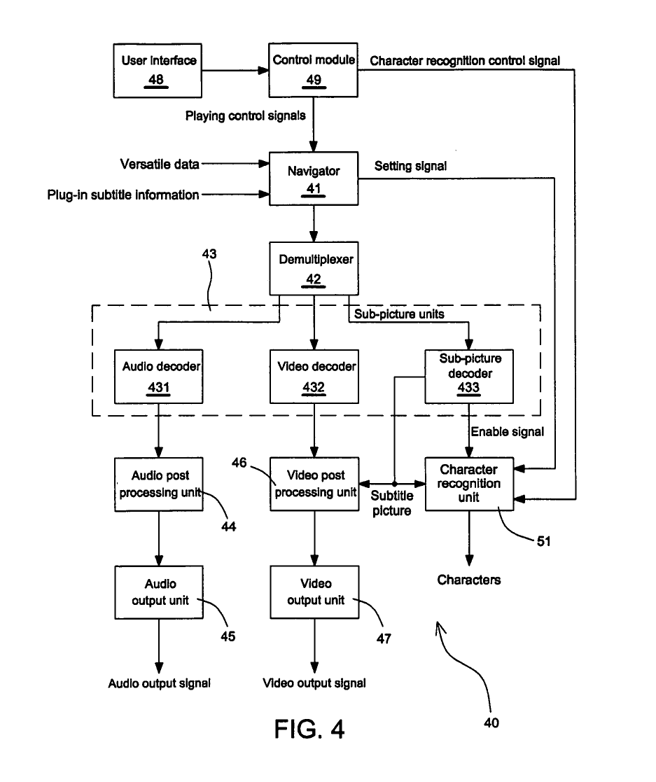

FIG. 4 illustrates a schematic architecture of a first embodiment of the DVD playback device capable of recognizing characters. As shown, the DVD playback device 40 comprises a navigator 41, a demultiplexer 42, a decoder 43, an audio post processing unit 44, an audio output unit 45, a video post processing unit 46, a video output unit 47, a user interface 48, a control module 49 and a character recognition unit 51. The decoder 43 includes an audio decoder 431, a video decoder 432 and a sub-picture decoder 433. As comparing to the prior DVD playback device schematically shown in FIG. 1, the DVD playback device 40 is additionally provided with a character recognition unit 51. In operation, the character recognition unit 51 performs the character recognition operation after receiving a character recognition control signal from the control module 49, a setting signal from the navigator 41, subtitle pictures and an enable signal from the sub-picture decoder 433. The navigator 41 not only retrieves general versatile data but also reads plug-in subtitle information. The reading operation and mechanism of the plug-in subtitle information are the same as the prior technologies associated therewith and the related description is omitted herein.

As above mentioned, the sub-picture decoder 433 generates each subtitle picture displaying unit and displaying information corresponding thereto, including time, position, color contrast information and the like. Therefore, an enable signal is generated simultaneously when the subtitle picture displaying unit is sent or displayed from the sub-picture decoder 433. In response to the subtitle picture displaying unit, the character recognition unit 51 may recognize the characters in the subtitle picture displaying unit.

However, recognition of characters is influenced by different languages, words and fonts corresponding to the characters. In light of this, the character recognition unit 51, as compared to the prior recognition technology, will load in different word libraries and character libraries after receiving the setting signal from the navigator 41, in which the setting signal comprises navigation data such as language and dimension of the characters. Further, the adopted recognition mechanism is different from the prior one, e.g. only 26 letters are required to be recognized when the to-be-recognized characters are English but they need to be combined into words. However, Chinese characters are required to be recognized each word. Alternatively, the character recognition unit 51 may further process the recognized characters in response to the character recognition control signal.

Generally, a character recognition operation may be divided into an image pre-processing step and an actual character recognition step. The image pre-processing step is performed to make the picture easy to be recognized and extract each character out of the characters in the image by analyzing them and the character recognition step is performed to recognize each of the characters and enhance correctness of the character recognition with an aid of the associated words stored in the word library. The character recognition operation is ordinary to a skilled person of the art and the description associated therewith will be omitted herein.

The character recognition unit 51 enters a character recognition mode only after a character recognition control signal is enabled. In the character recognition mode, the character recognition unit 51 first set a language corresponding to the to-be-recognized characters according to the setting signal from the navigator 41, such as Chinese, English, Japanese and the like. Also, a language library as required is loaded in, such as information corresponding to the language set. In addition, a corresponding algorithm used for character recognition may also be loaded in. As mentioned above, the character recognition unit 51 will detect the enable signal and recognize the characters in the subtitle picture outputted from the sub-picture decoder 433 when the enable signal is enabled. Then, the character recognition unit 51 outputs recognized character codes, such as ASCII codes when English is the language corresponding to the characters. In actual operation, the character recognition unit 51 may be incorporated or integrally formed in the sub-picture decoder 433.

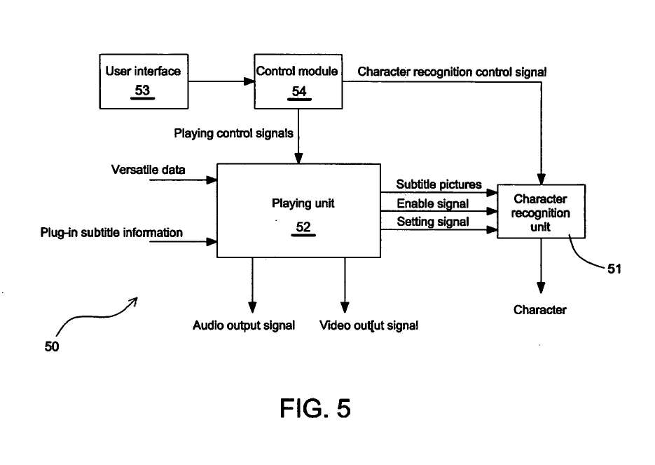

Referring to FIG. 5, another embodiment of the DVD playback device capable of recognizing characters according to the present invention is illustrated therein. As shown, the DVD playback device 50 comprises a playing unit 52, a character recognition unit 51, a user interface 53 and a control module 54. The playing unit 52 generates audio and video output signals after receiving audio and video data. In addition to the versatile data information, the playing unit 52 may also receive plug-in subtitle information. Besides the audio and video output signals, the playing unit 52 also outputs subtitle pictures corresponding to the subtitle information, an enable signal and a setting signal to the character recognition unit 51. In addition to a playing control signal, the control module 54 also outputs a character recognition control signal to the character recognition unit 51, such as controlling activating the character recognition function of the character recognition unit 51 and selecting a specific type of character codes corresponding to the characters.

After receiving the subtitle pictures, the enable signal and the setting signal, the character recognition unit 51 recognizes the characters in the subtitle pictures and outputs the character codes corresponding thereto. The outputted character codes have different formats and definitions depending upon the language and the character recognition control signal. For examples, if the corresponding language is English, the character codes used are ASCII codes. If the corresponding language is traditional Chinese, the character codes used are BIG5 codes. The “enable signal” is thus named since when it is received, the character recognition unit 51 is triggered to recognize the characters in the subtitle pictures. The “setting signal” is thus named since the language corresponding to the characters to be recognized by the character recognition unit 51 is set by this signal, which is issued by the playing unit 52 according to navigation data corresponding to the to-be played subtitle pictures. With the language information from the setting signal, the character recognition unit 51 may use the corresponding library and algorithm in its character recognition task.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

1. A DVD playback device capable of recognizing characters, comprising:
a control module for generating a playing control signal in response to an operation command;
a navigator for retrieving versatile data and generating an output signal and a setting signal in response to the playing control signal;
a demultiplexer for receiving the output signal from the navigator and outputting audio data, video data and sub-picture units;
a sub-picture decoder for receiving and analyzing the sub-picture units and generating an enable signal and subtitle pictures;
an audio decoder for receiving the audio data and generating a decoded audio signal;
a video decoder for receiving the video data and generating a decoded video signal; and
a character recognition unit for recognizing characters in the subtitle pictures in response to the setting signal and generating character codes.

2. The DVD playback device according to claim 1, wherein the control module also outputs a character recognition control signal.

3. The DVD playback device according to claim 2, wherein the character recognition unit further receives the character recognition control signal and outputs the character codes in response to the character recognition signal.

4. The DVD playback device according to claim 1, wherein the setting signal comprises navigation data corresponding to the sub-picture units.

5. The DVD playback device according to claim 1, wherein the navigator further reads plug-in subtitle information.

6. The DVD playback device according to claim 1, wherein the sub-picture decoder enables the enable signal when a different subtitle picture is to be outputted.

7. The DVD playback device according to claim 6, wherein the character recognition unit receives the subtitle pictures and recognizes characters in the subtitle pictures in response to the enable signal.

8. The DVD playback device according to claim 7, wherein the character recognition unit recognizes the characters in the subtitle pictures by using a library and an algorithm set by the setting signal.

9. The DVD playback device according to claim 1, further comprising:
a user interface for generating the operation command in response to a user's operation;
a video post processing unit for receiving the decoded video signal and the subtitle pictures and generating a video signal; and
a video output unit for generating a video output signal in response to the video signal.

10. The DVD playback device according to claim 1, further comprising:
an audio post processing unit for generating an audio signal in response to the decoded audio signal; and
an audio output unit for generating an audio output signal in response to the audio signal.

11. A DVD playback device capable of recognizing characters, comprising:
a playing unit for receiving versatile data to generate an audio output signal, a video output signal, subtitle pictures, an enable signal and a setting signal;
a character recognition unit for receiving the subtitle pictures, the enable signal and the setting signal, recognizing characters in the subtitle pictures and outputting character codes; and
a control module for controlling the character recognition and outputting a playing control signal to the playing unit.

12. The DVD playback device according to claim 11, further comprising a user interface for generating an operation command in response to a user's command.

13. The DVD playback device according to claim 12, wherein the character recognition unit recognizes the characters in the subtitle pictures by using a library and an algorithm set by the setting signal.

14. The DVD playback device according to claim 11, wherein the playing unit further receives plug-in subtitle information, outputs the subtitle pictures corresponding thereto and outputs the setting signal according to navigation data corresponding to the plug-in subtitle information.

15. The DVD playback device according to claim 11, wherein the control module further outputs a character recognition signal.

16. The DVD playback device according to claim 15, wherein the character recognition unit outputs the character codes in response to the character recognition control signal.
